(19) United States
(12) Patent Application Publication
(10) Pub. No.: US 2010/0080078 A1
(43) Pub. Date: Apr. 1, 2010

(54) METHOD AND APPARATUS FOR HOMOGENIZING A GLASS MELT

(76) Inventors: Martin Herbert Goller, Painted Post, NY (US); David Myron Lineman, Painted Post, NY (US); Matthew Carl Morse, Campbell, NY (US); Robert Richard Thomas, Watkins Glen, NY (US)

Correspondence Address: CORNING INCORPORATED, SP-TI-3-1, CORNING, NY, 14831, US

(21) Appl. No.: 12/240,285

(22) Filed: Sep. 29, 2008

(51) Int. Cl. B01F 15/06

(52) U.S. Cl. 366/145; 366/147; 366/146

(57) ABSTRACT

The present invention is directed toward a method of reducing contamination of a glass melt by volatilized precious metal oxides that may condense on the stirrer shaft of a stirring vessel and fall back into the glass melt, by heating the shaft. In one embodiment, the stirrer shaft includes an interior cavity and a heating element disposed within the cavity. The heating element heats the shaft to a temperature sufficient to prevent volatilized materials from condensing on the surfaces of the shaft.

### BACKGROUND OF THE INVENTION

1. Field of the Invention

The invention relates generally to a method of reducing contaminants in a glass melt, and more specifically to reducing condensation-formed contaminants during a glass stirring process.

2. Technical Background

Chemical and thermal homogeneity is a crucial part of good glass forming operations. The function of a glass melting operation is generally to produce glass with acceptable levels of gaseous or solid inclusions, but this glass usually has cord (striae or ream) of chemically dissimilar phases. These non-homogeneous components of the glass result from a variety of normal occurrences during the melting process including refractory dissolution, melting stratification, glass surface volatilization, and temperature differences. The resulting cords are visible in the glass because of color and/or index differences.

One approach for improving the homogeneity of glass is to pass the molten glass through a stir chamber located downstream of the melter. Such stir chambers are equipped with a stirrer having a central shaft that is rotated by a suitable motor. A plurality of blades extend from the shaft and serve to mix the molten glass as it passes from the top to the bottom of the stir chamber. The present invention is directed to the operation of such stir chambers without introducing further defects into the resulting glass, specifically, defects arising from condensed oxides.

Volatile oxides in a glass stir chamber can be formed from any of the elements present in the glass and stir chamber. Some of the most volatile and damaging oxides are formed from Pt, As, Sb, B, and Sn. Primary sources of condensable oxides in a glass melt include hot platinum surfaces for PtO₂, and the free glass surface for B₂O₃, As₄O₆, Sb₄O₆, and SnO₂. By free glass surface what is meant is the surface of the glass that is exposed to the atmosphere within the stir chamber. Because the atmosphere above the free glass surface, and which atmosphere may contain any or all of the foregoing, or other volatile materials, is hotter than the atmosphere outside of the stir chamber, there is a natural tendency for the atmosphere above the free glass surface to flow upward through any opening, such as through the annular space between the stirrer shaft and the stir chamber cover. Since the stir chamber shaft generally becomes cooler as the distance between the stirrer shaft and the glass free surface increases, the volatile oxides contained within the stir chamber atmosphere can condense onto the surface of the shaft if the shaft and/or cover temperature are below the dew point of the oxides. Condensation may occur on other relatively cool surfaces as well, including the stirrer cover, and in particular the annular region of the stirrer cover. When the resulting condensates reach a sufficient size they can break off, falling into the glass and causing inclusion or blister defects in the glass product.

### SUMMARY

In one embodiment according to the present invention, a method of stirring a glass melt is disclosed comprising flowing molten glass through a stir chamber, the stir chamber comprising a cover having a passage therethrough, the stir chamber further including a stirrer comprising a shaft extending through the cover passage and forming an annular gap between the stirrer shaft and the cover, and heating a portion of the stirrer shaft with a heating element disposed in an interior cavity of the stirrer shaft.

In another embodiment, an apparatus for stirring a glass melt is described comprising a stir chamber configured to hold molten glass, the stir chamber including a cover defining a passage therethrough, a stirrer comprising a shaft extending through the passage into the stir chamber, the cover and the stirrer shaft defining an annular gap therebetween, and wherein the stirrer shaft defines a cavity interior to the shaft and a heating element disposed within the stirrer shaft cavity for heating at least a portion of the shaft passing through the annular gap.

In still another embodiment, an apparatus for stirring a glass melt is disclosed comprising a stir chamber configured to hold molten glass, the stir chamber including a cover defining a passage therethrough, a stirrer having a shaft extending through the passage into the stir chamber, the space between the cover and the shaft defining an annular gap and at least one infrared heating element positioned external to the shaft for heating a portion of the shaft proximate the annular gap.

The invention will be understood more easily and other objects, characteristics, details and advantages thereof will become more clearly apparent in the course of the following explanatory description, which is given, without in any way implying a limitation, with reference to the attached Figures.

### BRIEF DESCRIPTION OF THE DRAWINGS

FIG. 1 is a plot of mass loss of platinum (vertical axis) versus oxygen partial pressure (horizontal axis) for four temperatures ranging from 1200° C. (lowest curve) to 1550° C. (upper curve).

FIG. 2 is a plot of mass loss of platinum (vertical axis) versus temperature (horizontal axis) for two oxygen levels (10% lower curve; 20% upper curve).

FIG. 3 is a plot of mass loss of platinum (vertical axis) versus gas flow (horizontal axis) for two temperatures (1550° C. lower curve; 1645° C. upper curve).

FIG. 4 is a plot of total pressure for each of the platinum-group metals platinum and rhodium (vertical axis) versus temperature (horizontal axis) for three different oxygen concentrations.

FIG. 5 depicts a cross sectional view of an exemplary chamber for stirring glass according to an embodiment of the present invention comprising a heating element disposed within an interior cavity defined by a stirrer shaft.

FIG. 6 is a cross sectional view of a portion of the interior cavity of FIG. 5 showing an exemplary resistance heating element according to an embodiment of the present invention.

FIG. 7 is a cross sectional view of a portion of the interior cavity of FIG. 5 showing an exemplary inductance heating element arranged on the inside of the stirrer shaft according to an embodiment of the present invention, including cooling supply line for supplying a coolant that travels through the heating element.

FIG. 8 is a cross sectional view of an exemplary stirring shaft showing an inductance heating element arranged on the outside of the stirrer shaft according to an embodiment of the present invention (coolant supply lines are not shown).

FIG. 9 is a cross sectional view of another embodiment of the present invention comprising an exemplary radiant heating element disposed external to and proximate the annular gap surrounding a stirrer shaft.

FIG. 10 is a cross sectional view of a laser radiant heating element for heating the stirrer shaft according to an embodiment of the present invention.

### DETAILED DESCRIPTION

As discussed above, the present invention relates to the problem of platinum-group defects in sheet glass. More particularly, it relates to the formation of condensates of platinum-group metals at locations in the manufacturing process at which flowing molten glass has a free surface and one or more exposed surfaces are located at or above the free surface. (As used herein, the phrase “at or above” when applied to the spatial relationship between a structure or surface which comprises a platinum-group metal and a free surface of flowing molten glass includes a structure or surface which is both at and above the free surface. Similarly the phrase “at or below” used for the same purpose includes the case where a free surface of flowing molten glass is both at and below a structure or surface which comprises a platinum-group metal.)

Because of the high temperatures involved, at certain locations at or above the free surface, platinum-group metals can undergo oxidization to form a vapor of the metal (e.g., a PtO₂ vapor) which can revert to the metal and condense into metal particles at other locations at or above the free surface. These platinum-group metal particles can then “rain” back onto the free surface or be entrained in the glass flow and thereby form defects (typically, inclusions) in the finished glass sheets.

Defects comprising a platinum-group metal formed by this mechanism (referred to herein as “platinum-group condensate defects” or simply “condensate defects”) have characteristics that distinguish them from defects comprising a platinum-group metal formed by other mechanisms. Thus, condensate defects are crystalline shaped and their largest dimensions are equal to or greater than 50 microns.

Without wishing to be held to any particular theory, it is believed that platinum-group condensate defects originate from the following chemical and thermodynamic effects. The primary source of the problem is a range of 2-way reactions that platinum-group metals can enter into with oxygen. For example, for platinum and rhodium, one of the 2-way reactions can be written:

Pt (s)+O₂ (g)⇄PtO₂ (1)

4Rh(s)+3O₂(g)⇄2Rh₂O₃ (2)

Other reactions involving platinum can generate PtO and other oxides, and other reactions involving rhodium can generate RhO, RhO₂, and other oxides.

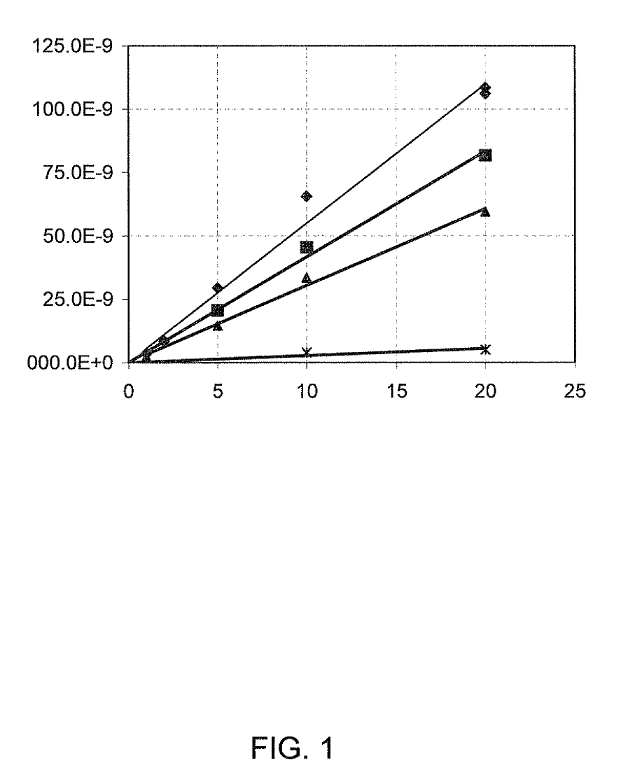

The forward direction of these reactions can be considered as the “originating source” (starting point) for platinum-group condensate defects. As illustrated in FIGS. 1-3, primary factors that influence the forward rate of these reactions are the partial pressure of oxygen pO₂, temperature, and flow velocity.

In particular, FIG. 1 shows the effect of pO₂ on the forward reaction of platinum for four different temperatures, i.e., 1200° C. — star data points; 1450° C. — triangular data points; 1500° C. — square data points; and 1550° C. — diamond data points. The horizontal axis in this figure is oxygen partial pressure in %, while the vertical axis is mass loss of platinum in grams/cm²/second. The straight lines are linear fits to the experimental data. As can be seen in FIG. 1, the oxidization and vaporization of platinum increases substantially linearly with oxygen partial pressure, with the slope of the effect becoming ever greater as the temperature increases.

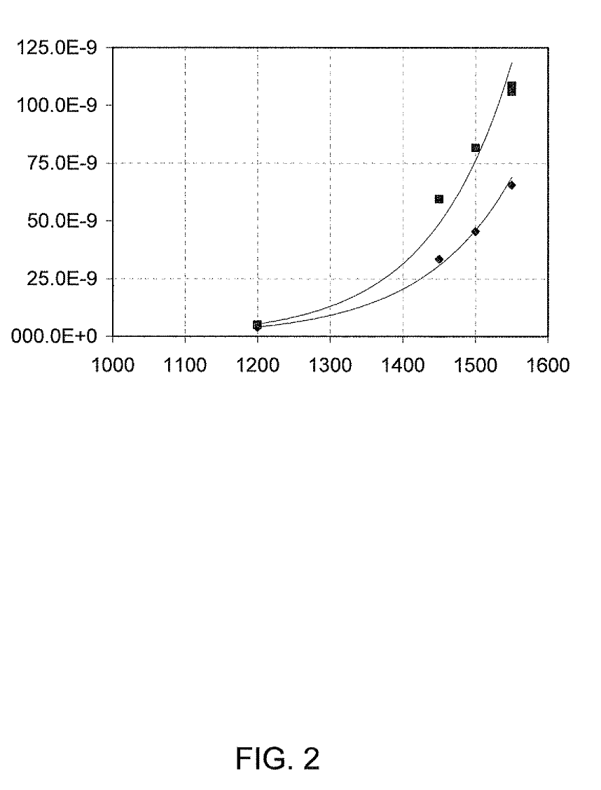

FIG. 2 shows the temperature effect in more detail. The horizontal axis in this figure is temperature in ° C., while the vertical axis is again mass loss of platinum in grams/cm²/second. The diamond data points are for an atmosphere having an oxygen partial pressure of 10%, while the square data points are for an oxygen partial pressure of 20%. The curves through the data points are exponential fits. The rapid (exponential) increase in platinum oxidization and vaporization with an increase in temperature is evident from this data. Although not shown in FIG. 2, other experiments have shown that the onset of Pt volatilization is ˜600° C.

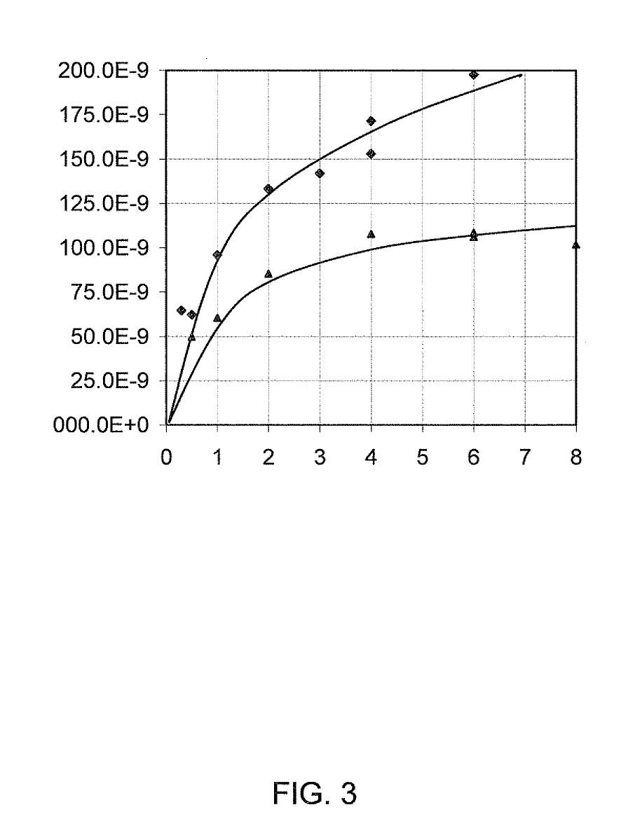

FIG. 3 shows the effects of the third major parameter involved in the oxidation and vaporization of platinum-group metals, i.e., flow rate of an oxygen containing atmosphere over the surface of the metal. The horizontal axis in this figure is flow rate in standard liters per minute (SLPM) through the vessel in which the platinum sample was housed for the test, while in FIG. 1 and FIG. 2, the vertical axis is mass loss of platinum in grams/cm²/second. The triangular data points are for a temperature of 1550° C., while the diamond data points were obtained at 1645° C. The oxygen partial pressure in both cases was 20%.

As can be seen in FIG. 3, the mass loss of platinum increases rapidly for both temperatures as one moves away from the stagnant condition and then tends to level off somewhat, especially at lower temperatures, as the flow rate increases. Although not wishing to be bound by any particular theory of operation, it is believed that a flow increase at exposed metal surfaces strips the oxide layer at the metal-gas interface and promotes more rapid oxidation. Flow is also believed to inhibit the establishment of an equilibrium vapor pressure of oxide over the metal surface which would kinetically reduce the rate of volatile specie generation.

Considering FIGS. 1-3 as a group, it can be seen that the originating source of platinum-group condensate defects, i.e., oxidation and vaporization of the platinum-group metal, increases with each of pO₂, temperature, and flow rate, with the combined effects being substantially additive. Thus, the originating source for condensate defects can be viewed as those areas of structures in the vicinity of a free surface of flowing molten glass where materials comprising a platinum-group metal are exposed to higher oxygen concentrations, higher temperatures, and/or higher flow rates than at other areas, the combination of two or all three of these conditions being the most offending (most troublesome) originating sources.

Oxidation/vaporization of platinum-group metals in and of itself does not lead to condensate defects. Rather, there needs to be a condensation of solids from the vapor/gaseous atmosphere over a free surface of flowing molten glass to produce particles which can “rain” down on the free surface or otherwise become entrained in the flowing glass and thus become condensate defects in the glass sheets. The backward reactions of the governing equations (1) and (2) above promote condensation of the platinum-group metals and thus can be thought of as the “sink” for solid particle formation.

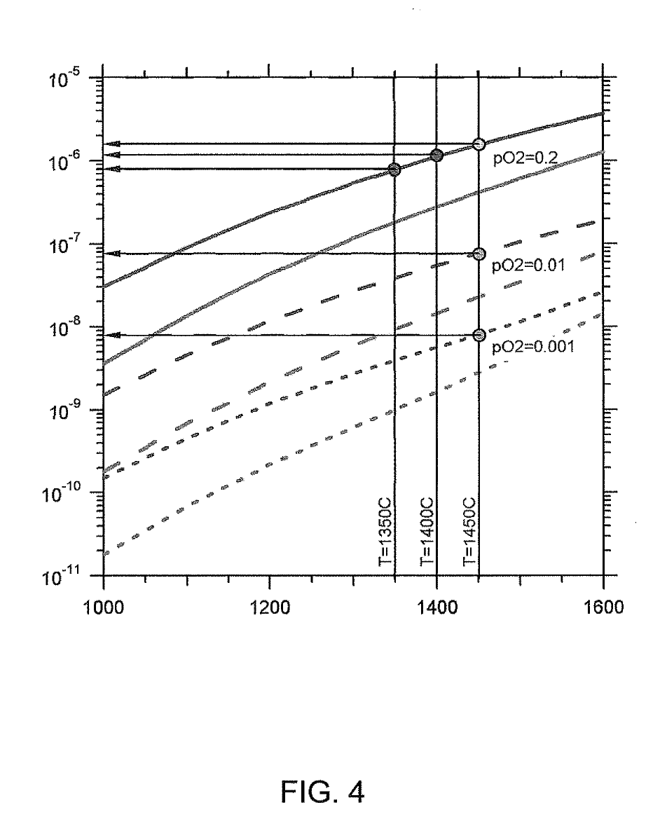

Factors responsible for accelerating the rate of the backward reactions include drops in temperature and/or pO₂. FIG. 4 illustrates the thermodynamics involved in the condensation process. The horizontal axis in this figure is temperature in ° C., while the vertical axis is total pressure in atmospheres of gaseous species containing the platinum-group metal. The thermodynamic calculations shown in this figure are for an 80 wt. % platinum—20 wt. % rhodium alloy. The pairs of (i) solid lines, (ii) dashed lines, and (iii) dotted lines denote atmospheres with pO₂ values of 0.2 atm, 0.01 atm, and 0.001 atm, respectively. For each pair of lines, the upper member of the pair represents platinum and the lower rhodium.

As can be seen in this figure, as platinum and/or rhodium vapors created in a high temperature area move into a colder region, they become unstable, resulting in condensation of solid particles of the parent metal. The three circled points at the top of the figure show this effect for platinum in an atmosphere having a pO₂ value of 0.2 atmospheres. As can be seen from these points, as the temperature drops from 1450° C. to 1350° C., the total pressure of platinum-containing species in the atmosphere must drop from about 1.5×10⁻⁶ atm to about 8.0×10⁻⁷ atm. The mechanism for this drop in gaseous pressure of platinum-containing species is condensation, i.e., transformation from the gaseous state to the solid state.

FIG. 4 also shows that as platinum and/or rhodium vapors created in a highly oxidized area move into an area with a lower oxygen level, formation of solid specie will again occur. The three circled points along the T=1450° C. line illustrate this effect. As pO₂ drops from 0.2 atm (the uppermost of the three points) to 0.001 atm (the lowermost), the total pressure of platinum-containing species in the atmosphere must drop from about 1.5×10⁻⁶ atm to about 8.0×10⁻⁹ atm. Again, this drop means that a solid form of platinum must be formed. That solid form constitutes the metal condensate particles that can fall back into, or be entrained into, the molten glass stream and create metal specks in the solidified glass sheets.

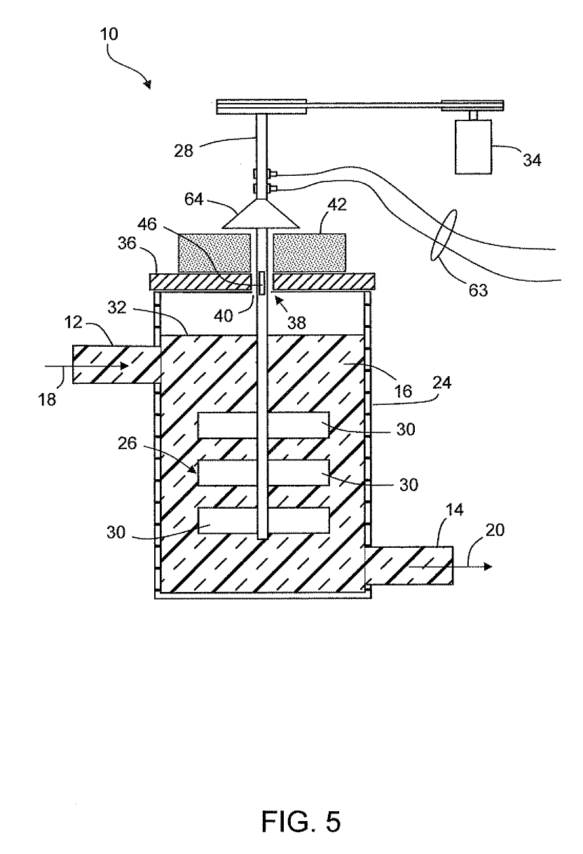

FIG. 5 illustrates an exemplary apparatus for practicing a method for homogenizing a glass melt according to an embodiment of the present invention. Stir chamber 10 of FIG. 5 includes an inlet pipe 12 and an outlet pipe 14. In the illustrated embodiment, molten glass 16 flows into the stir chamber, as indicated by arrow 18, through inlet pipe 12, and flows out of the chamber, as shown by arrow 20, through outlet pipe 14. Stir chamber 10 includes at least one wall 24 that is preferably cylindrically-shaped and typically substantially vertically-oriented, although stir chamber 10 may have other shapes and orientations. Preferably, the stir chamber wall comprises platinum or a platinum alloy.

Stir chamber 10 further includes a stirrer 26 comprising shaft 28 and a plurality of blades 30 which extend outward from the shaft towards wall 24 of the stir chamber. Shaft 28 is typically substantially vertically-oriented and rotatably mounted such that blades 30 that extend from the lower portion of the shaft rotate within the stir chamber at least partially submerged below free surface 32 of molten glass 16. Stirrer 26 may, for instance, be rotated by an electric motor 34 through appropriate gearing or by a belt or chain drive. The molten glass surface temperature is typically in the range between about 1400° C. to 1600° C., but may be higher or lower depending upon the glass composition. Stirrer 26 is preferably comprised of platinum, but may be a platinum alloy—for example, a dispersion-strengthened platinum (e.g., a zirconia-strengthened or rhodium oxide platinum alloy), or any other refractory material suitable for stirring molten glass.

In accordance with the present embodiment, stir chamber 10 further comprises stir chamber cover 36. Stir chamber cover 36 may rest directly on wall 24, or high temperature sealing material may be disposed between the wall and the cover, the seal between the wall and the cover in any event being sufficient to prevent appreciable gas flow between the cover and the wall. Chamber cover 36 also defines a passage 38 through which stirrer shaft 28 passes. Shaft 28 passing through the chamber cover passage forms annular gap 40 between shaft 28 and cover 36. Chamber cover 36 is typically covered by a refractory insulating layer 42 that may also be positioned about at least a portion of shaft 28.

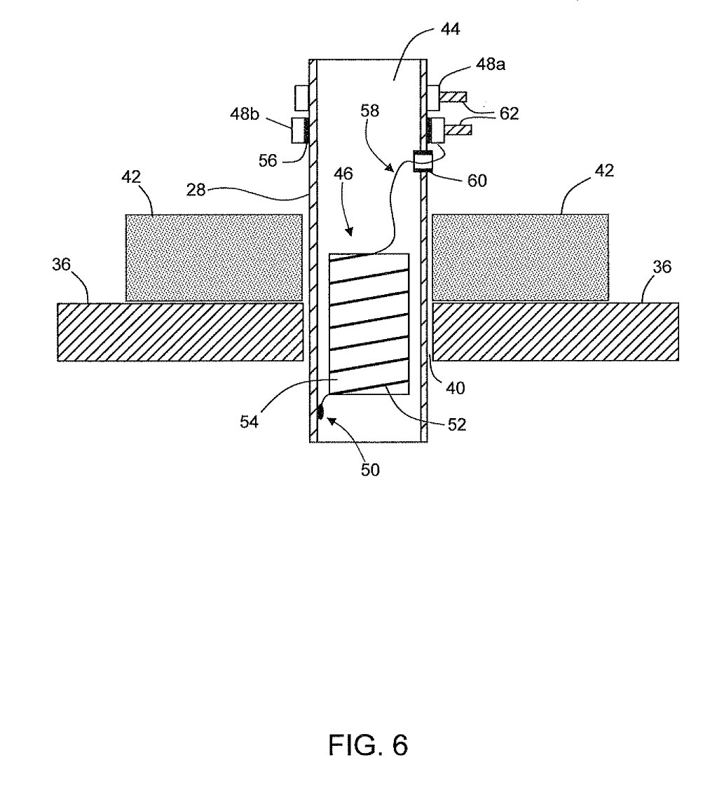

According to the present embodiment, and as best shown in FIG. 6, at least a portion of shaft 28 adjacent annular gap 40 defines cavity 44 comprising heating element 46 disposed therein, preferably adjacent annular gap 40. Stirrer shafts may be hollow to conserve on the use of expensive platinum, or platinum alloys. In the embodiment shown in FIG. 6, conducting rings 48a and 48b function to deliver an electrical current to heating element 46. Heating element 46 may be, for example, a resistance heating element as shown in FIG. 5. Accordingly, first conducting ring 48a is in electrical communication with shaft 28, as well as one end of the resistance element (i.e. at point 50). The resistance element may be, for example, a coil of high temperature wire 52 (such as platinum, tungsten, molybdenum or alloys thereof) that is disposed about refractory form 54 constructed from a high temperature ceramic (e.g. AN485). Alternatively, a resistance element may be one or more metallic strips, bars or other forms of resistance element. The resistance element may be disposed in a groove formed in a surface of refractory form 54 for example. The exemplary resistance element in FIG. 6 is shown as a coil.

In some embodiments, cavity 44 may comprise an inert atmosphere, such as an atmosphere comprising nitrogen or helium, to prevent oxidation of the heating element. An inert atmosphere may be practical particularly for resistance elements such as tungsten that, though having high current carrying capability, may be particularly prone to oxidation. Other inert gases, such as the family of noble gases, may be employed.

Second conducting ring 48b is disposed about, but electrically insulated from shaft 28 by insulating layer 56. For example, a portion of the exterior of shaft 28 may be coated with an electrically insulating ceramic refractory insulating layer 42 (e.g. Alundum AN485 or equivalent) disposed between second conducting ring 48b and shaft 28. The other end 58 of the resistance element passes through shaft 28 (e.g. via insulating bushing 60) and is connected to second conducting ring 48b. Brushes 62 supply a current from a current supply (not shown) via electrical supply lines 63 (FIG. 1) to conducting rings 48a, 48b that then flows through the heating element. Brushes 62 may be carbon brushes, or may comprise copper or any other material suitable as an electrical brush. Preferably, the current is an alternating current. Preferably, conducting rings 48a, 48b are located a sufficient vertical distance from annular gap 40 to minimize the condensation of volatile materials that may issue from gap 40 on the conducting rings, while at the same time minimizing heating of the conducting rings.

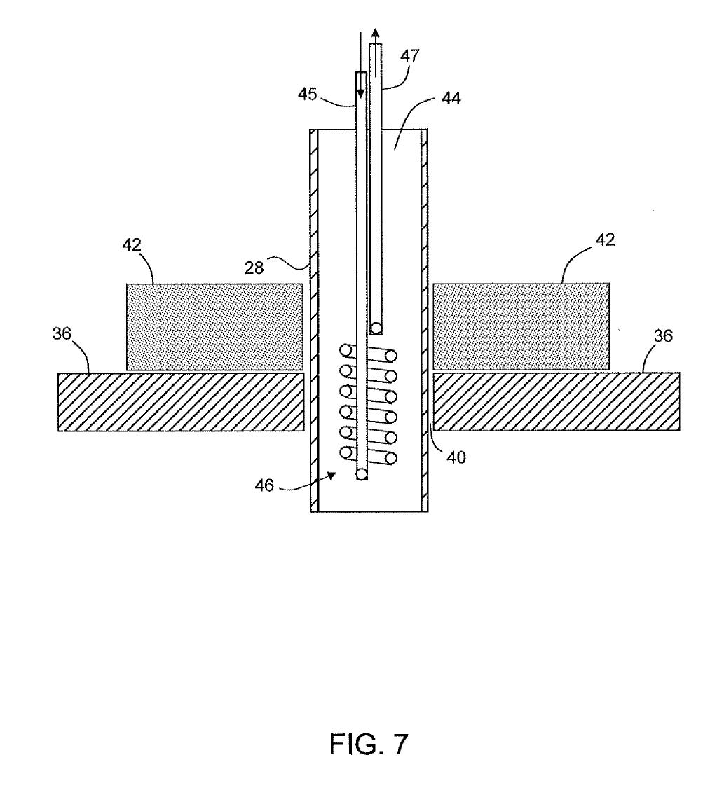

In an alternative embodiment, heating element 46 may be an induction coil, shown in the cross sectional view of FIG. 7, to facilitate direct induction heating of shaft 28. Because of the high electrical current such coils may carry, they are typically hollow so that a cooling fluid may be flowed through the coil. Thus, rotating connections or joints (not shown) may be needed to supply move cooling fluid (e.g. water) to and from the interior of the coil through coolant delivery lines 45, 47, respectively.

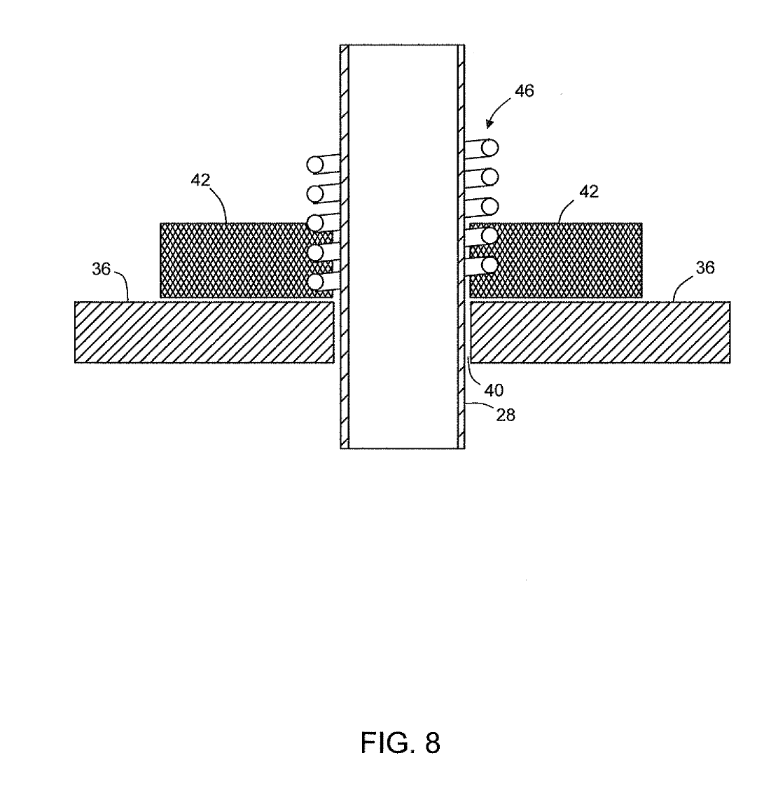

In yet another embodiment shown in FIG. 8, induction heating may be used by positioning an induction heating coil external to the shaft to heat the shaft. The power applied to the coil can be adjusted such that the coils is placed a distance from the shaft sufficient to prevent condensation of volatiles on the coil. As before, the induction coil should be selected such that it is capable of heating at least a portion of shaft 28 near gap 40 to a temperature of at least about 400° C., preferably at least about 600° C., more preferably to at least about 1200° C., and still more preferably to at least about 1400° C. As before, the induction coil is typically supplied with a cooling fluid through cooling passages (not shown).

A plurality of heating elements 46 may be disposed in cavity 44 to create a pre-determined temperature gradient along the length of shaft 28 proximate annular gap 40. Concurrently, a plurality of pairs of conducting rings may also used.

Heating element 46 should be capable of heating at least a portion of shaft 28 to a temperature of at least about 400° C., preferably at least about 600° C., more preferably to at least about 1200° C., and still more preferably to at least about 1400° C.

In one embodiment, shield 64 (FIG. 5) may be used to deflect volatile gases flowing upward through annular gap 40 from condensing on conducting rings 48a, 48b, and prevent debris, such as eroded or abraded particulate (e.g. carbon dust) from brushes 62 from falling downward through annular gap 40 into the interior of stir chamber 10.

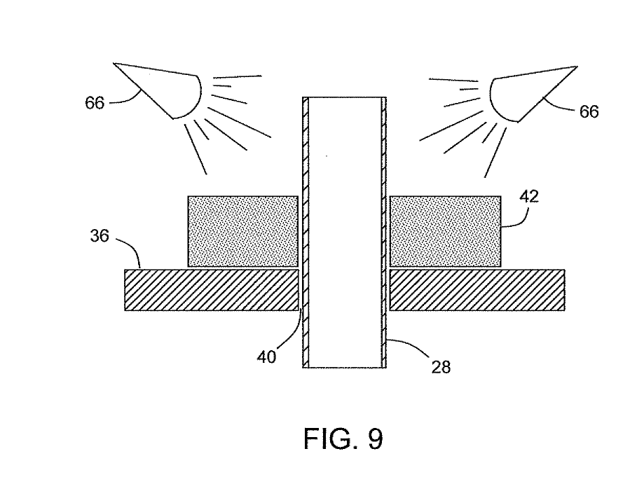

In still another embodiment shown in FIG. 9, one or more radiant sources 66 (e.g. quartz infrared heaters) may be positioned about shaft 28 to heat shaft 28 proximate annular gap 40. Such heating elements are readily commercially available in a variety of shapes, sizes and power output. Infrared quartz heaters may be arranged equidistant from each other (angularly) about shaft 28. Advantageously, the use of radiant heaters 66 allows placement of the heaters a sufficient distance away from annular gap 40 to preclude condensation of volatile materials flowing from annular gap 40 and subsequent corrosion of the heaters due to condensation on the heaters. Preferably, radiant heaters 66 are configured to maintain a temperature of shaft 28 proximate annular gap 40 at a temperature of at least about 400° C., preferably at least about 600° C., more preferably to at least about 1200° C., and still more preferably to at least about 1400° C. The closer the target temperature is to the temperature within the stirring chamber, the more effective the heating will be in terms of preventing condensation of volatile gases from the chamber. However, any increase in temperature of the shaft above a temperature of the shaft without auxiliary heating of the shaft provides benefit.

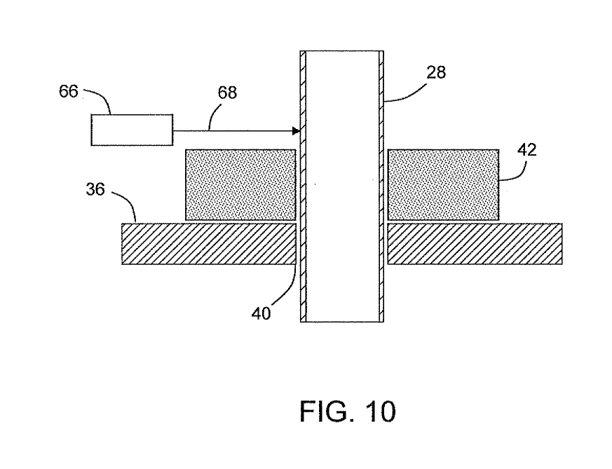

Alternatively, one or more lasers may be used to radiatively heat the shaft as shown in FIG. 10, wherein radiant source 66 (laser 66) produces laser beam 68 that is directed at shaft 28 near annular gap 40. If need be, portions of insulating layer 42 may be removed to facilitate moving laser beam 68 closer to annular gap 40. Preferably, the laser is an infrared laser that produces infrared light energy. Radiant heating element 66 should be capable of irradiating shaft 28 with sufficient power to heat at least a portion of shaft 28 near gap 40 to a temperature of at least about 400° C., preferably at least about 600° C., more preferably to at least about 1200° C., and still more preferably to at least about 1400° C. In yet another alternative, a microwave generator (e.g. gyrotron) may be used as radiant source 66.

An experiment demonstrating radiant heating elements was conducted with a pair of 1000 watt heaters and a platinum stirrer shaft. The heaters were run on standard 120 volt electric and required a small amount of water cooling (less than 1 gallon per minute). They included a tungsten filament capable of heating parts positioned near the heaters to about 1600° C. The shaft was heated from 775° C. to 875° C. in several minutes with the heaters set at 80% output. These heaters were not optimized for this application. How much energy actually gets absorbed by the shaft is dependent, inter alia, on the emissivity and the absorbance of irradiating energy by the shaft. In the simulation, with the shaft rotating, temperature was uniform around the circumference of the shaft.

It will be apparent to those skilled in the art that various other modifications and variations can be made to the present invention without departing from the spirit and scope of the invention. Thus it is intended that the present invention cover the modifications and variations of this invention provided they come within the scope of the appended claims and their equivalents.

What is claimed is:

1. A method of stirring a glass melt comprising:
flowing molten glass through a stir chamber, the stir chamber comprising a cover having a passage therethrough, the stir chamber further including a stirrer comprising a shaft extending through the cover passage and forming an annular gap between the stirrer shaft and the cover; and
heating at least a portion of the stirrer shaft with a heating element disposed in an interior cavity of the stirrer shaft.

2. The method according to claim 1, wherein the heating comprises a plurality of heating elements.

3. The method according to claim 2, wherein a heat output of at least one of the plurality of heating elements is modified to produce a pre-determined temperature gradient along a length of the stirrer shaft.

4. The method according to claim 1, wherein a temperature of the shaft passing through the annular gap is maintained equal to or greater than about 400° C.

5. The method according to claim 1, wherein the heating element comprises a metal selected from the group consisting of platinum, tungsten, molybdenum, or an alloy thereof.

6. The method according to claim 1, wherein the cavity comprises an inert gas disposed therein.

7. The method according to claim 1 wherein the heating element is in electrical communication with an electrical conducting ring positioned on the stirrer shaft.

8. The method according to claim 1, wherein the shaft is heated inductively.

9. The method according to claim 1 wherein the heating element is a resistance coil or an induction coil.

10. The method according to claim 1 wherein the heating element is adjacent to the annular gap.

11. An apparatus for stirring a glass melt comprising:
a stir chamber configured to hold molten glass, the stir chamber including a cover defining a passage therethrough;
a stirrer comprising a shaft extending through the passage into the stir chamber, the cover and the stirrer shaft defining an annular gap therebetween, and wherein the stirrer shaft defines a cavity interior to the shaft; and
a heating element disposed within the stirrer shaft cavity for heating at least a portion of the shaft passing through the annular gap.

12. The apparatus according to claim 11, further comprising a plurality of heating elements disposed within the stirrer shaft cavity.

13. The apparatus according to claim 12, wherein the plurality of heating elements are configured to impart a predetermined temperature distribution along a length of the shaft.

14. The apparatus according to claim 11 further comprising a shield disposed about the shaft above the cover.

15. The apparatus according to claim 11 further comprising a conducting ring in contact with the shaft for supplying an electrical current to the heating element.

16. The apparatus according to claim 11, wherein the heating element is an induction coil.

17. The apparatus according to claim 11, wherein the cavity comprises an inert atmosphere disposed therein.

18. An apparatus for stirring a glass melt comprising:
a stir chamber configured to hold molten glass, the stir chamber including a cover defining a passage therethrough;
a stirrer having a shaft extending through the passage into the stir chamber, a space between the cover and the shaft defining an annular gap; and
at least one radiant heating element positioned external to the shaft for irradiating a portion of the shaft proximate the annular gap with a light having sufficient power to heat at least a portion of the shaft to a temperature of at least about 400° C.

19. The apparatus according to claim 18, wherein the radiant heating element is an infrared light source.

20. The apparatus according to claim 18, wherein the radiant heating element is a laser.

21. A method of stirring a glass melt comprising:
flowing molten glass through a stir chamber, the stir chamber comprising a cover having a passage therethrough, the stir chamber further including a stirrer comprising a shaft extending through the cover passage and forming an annular gap between the stirrer shaft and the cover; and
heating at least a portion of the stirrer shaft with a radiant heating element that irradiates the portion of the shaft with a light having a power sufficient to heat the irradiated portion of the shaft to a temperature of at least about 400° C.

22. The method according to claim 21, wherein the radiant heating element is a laser.

23. The method according to claim 21, wherein the light is an infrared light.
